(19) United States
(12) Patent Application Publication
(10) Pub. No.: US 2003/0151209 A1
(43) Pub. Date: Aug. 14, 2003

(54) Sealing cord and packing system comprising a plurality of such sealing cords

(76) Inventors: Hans-Peter Schmid, Burgberg (DE); Detlef Steidl, Burgberg (DE); Jurgen Maurer, Immenstadt (DE); Wolgang Suss, Sonthofen (DE); Thomas Cleff, Taufkirchen (DE); Siegfried Kindenmann, Ottobrunn (DE)

Correspondence Address: BAKER & BOTTS, 30 ROCKEFELLER PLAZA, NEW YORK, NY, 10112

(21) Appl. No.: 10/300,131

(22) Filed: Nov. 20, 2002

(30) Foreign Application Priority Data
Nov. 22, 2001 (DE) 101 57 297.2

(51) Int. Cl. F16J 15/46

(52) U.S. Cl. 277/387; 277/944

(57) ABSTRACT

A sealing cord (10) for sealing shafts (14) or other movable machine and equipment parts includes a core (24) having an elastically deformable hollow section (26), the hollow section (26) comprising at least one chamber (26), and a braiding (28) surrounding the core (24). The at least one chamber (26) is equipped with at least one connection (30) for the supply and/or discharge of pressurized fluid (32).

### BACKGROUND OF THE INVENTION

1. The Field of the Invention

The present invention relates to a sealing cord for sealing shafts or other movable machine and equipment parts, such as slides, valves, housings and the like, in particular in agitators, mixers, dryers, filters and cover seals, and more particularly, to a sealing cord having a core with an elastically deformable hollow section, which includes at least one chamber, and a braiding surrounding the core. The invention also relates to a packing system comprising a plurality of such sealing cords and means for supplying pressurized fluid to the chamber(s) in each cord.

2. The Related Art

Such a sealing cord is disclosed in, for example, the commonly-owned, laid-open German application DE 195 32 795 A1, the disclosure of which is hereby expressely incorporated herein for all purposes.

The core of this earlier sealing cord, formed by a hollow space, in addition to sealing also serves for the accommodation of major motions of the two parts to be sealed relative to one another; for example, a shaft relative to its bearing in a direction substantially orthogonal to the contact surfaces of the sealing cord on the two parts. Specifically, for this purpose, the chamber within the core is elastically deformed under compression, while, however, its peripheral length does not change substantially. To produce a packing, a plurality of such sealing cords is inserted in a packing space one after another and then compressed by tightening a packing gland in a feed direction until the desired sealing effect is obtained. In such packings, adjustment of the packing gland, for the purpose of, for example, compensation of frictional wear on the sealing cords, is frequently made difficult by attachments on the parts to be sealed relative to one another. Replacement of a worn packing by a new packing is even more difficult.

For applications in which only stationary sealing is required, such as, for example, the sealing of hatches and the covers closing them, in principle the use of inflatable hose seals is also known.

Reference is also made to the following prior art documents: FR-A-1,377,982, FR-A-2,087,356, DE-C-18,970, DE-C-2,293, DE-B-1,217,716, U.S. Pat. Nos. 1,076,282, 1,150,050, 1,313,201, 1,733,880, and 1,946,527.

### SUMMARY OF THE INVENTION

It is an object of the present invention to provide a sealing cord of the aforementioned type that permits simple production and adjustment of the sealing effect of the sealing cord in a packing.

According to the invention, this object is accomplished by a generic sealing cord in which at least one chamber within the cord core is equipped with at least one connection for the supply and/or discharge of a pressurized fluid.

For the assembly of a packing from the sealing cord according to the invention, the cord need only be inserted into the packing space provided for it and the latter then closed by means of a cover. Also, the cover need not be displaceable in the manner of a packing gland. In principle, it is even possible to consider the use of cover-free packing spaces, specifically when the packing space is particularly accessible, for example after removal of a shaft from its bearing. Then the at least one pressure chamber of the sealing cord is supplied with pressurized fluid via the connection provided for it, whereupon the elastically deformable hollow section within the cord expands until the desired sealing effect is obtained. Wear of the sealing cord can be compensated for simply by the supply of additional pressurized fluid, making it possible to compensate for wear in equipment that is running.

An additional advantage of the present invention is to be seen in the following: In an axially sequential arrangement of a plurality of sealing cords according to the invention, for example for the sealing of a shaft, the pressure exerted by the packing gland in the axial direction conventionally had to be transmitted from sealing cord to sealing cord. This necessarily resulted in a reduction of the sealing effect from the sealing cord lying next to the packing gland to the sealing cord lying farthest from the packing gland. According to the invention, on the other hand, pressurized fluid can be supplied separately to each sealing cord, so that each of the cords, regardless of its position in the sealing package, is able to develop its sealing effect fully as a function only of the fluid pressure supplied to it.

It is to be noted that, for production of the sealing effect, the elastically deformable hollow section of the sealing cord according to the invention expands owing to the supply of pressurized fluid, i.e., the peripheral length of the sealing cord increases as a result of the supply of pressurized fluid. Such an expansion previously was not contemplated in generic hollow sections, since heretofore the hollow section was always firmly embedded in the braiding, and the materials usually used for the braiding, which were not readily replaceable because of their sealing and slipping properties in practice, had no usable elasticity. By way of example only, reference is made to carbon fibers and Teflon. Surprisingly, however, it has been found that by appropriate selection of the mesh, i.e., the type of braiding, and insofar as possible also by suitable material selection, a limited but sufficient elasticity of the braiding can be obtained for the purposes according to the invention.

Selection of the cross-sectional shape of the sealing cord according to the invention may be made as a function of the respective application. In particular, the sealing cord may have a square, rectangular, trapezoidal, round or oval cross section. However, other shapes are alternatively possible; for example, a flat oval cross section, as is known in, for example, hoses used for fire-fighting.

Especially for sealing cords with an angular cross section, it is proposed that the limiting wall of the at least one pressure chamber in a substantially orthogonal cross section be convex toward the pressure chamber, at least in sections. Owing to stretching and possibly also expansion of the convex wall section as a result of expansion of the elastically deformable hollow section, the sealing effect can be reinforced above all in the areas assigned to the ends of the convex section. Therefore, these areas preferably will be assigned to the comers of the sealing-cord cross section, which are critical for sealing.

The hollow section may of course alternatively have any desired cross-sectional shape supporting the sealing effect, in particular upon expansion after the supply of pressure fluid.

To increase the sealing effect in areas critical for sealing, it may additionally or alternatively be provided that a plurality of pressure chambers are arranged distributed over the cross section of the sealing cord. Such plurality of pressure chambers may be designed in a plurality of hollow sections, which are braided together, as well as in a single hollow section. In principle, a combination of these two possibilities is also possible.

In order to obtain as uniform as possible a pressure distribution, it is proposed that when the sealing cord has a closed endless course, as is the case, for example, in the sealing of shafts, the at least one chamber is a self-contained annular chamber. In principle, however, it is alternatively possible that a plurality of separate chambers separated from one another are provided along an endless course. A pressure and sealing section varying over the length of the sealing cord may alternatively be obtained by means of this last-mentioned alternative embodiment.

In a simple and inexpensive-to-produce embodiment, the at least one pressure chamber may have a common connection for the supply and discharge of pressurized fluid. Alternatively, it is likewise possible that the at least one pressure chamber has a separate connection for the supply and discharge of pressurized fluid in each instance. This last-mentioned alternative embodiment has the further advantage that the pressurized fluid flows through the pressure chamber, whereby the pressure consequently can be controlled or regulated dynamically and, hence, especially sensitively. In addition, this embodiment makes it possible to use the pressurized fluid simultaneously as a cooling fluid, which in the most favorable case even allows an increase the permissible sliding velocity between the sealing cord and the part to be sealed off.

In a refinement of the invention, the sealing cord may be assigned a pump that supplies the at least one pressure chamber with fluid under pressure. In addition, control means comprising valves may be provided for controlling the supply and/or discharge of pressurized fluid. Nitrogen gas, for example, may be used as pressurized fluid. With regard to the use of pressurized fluid as cooling fluid, in view of their high heat absorption capacity, liquid media may alternatively be used.

Lastly, the expansibility desired according to the invention may be obtained by manufacture of the elastically deformable hollow section of silicon and/or EPDM, and/or Viton, and/or polyethylene, and/or polypropylene, and/or polytetrafluoroethylene.

In addition, the invention relates to a packing comprising a plurality of sealing cords according to the invention.

### DESCRIPTION OF DRAWINGS

The invention will be explained below in detail by several examples with reference to the accompanying drawing, wherein:

FIG. 1 shows a longitudinal section through equipment in which one embodiment of a sealing cord according to the invention is used in a packing; and

FIGS. 2a-2f illustrate examples for the arrangement of pressure chambers and the supply and/or discharge of pressurized fluid to or from the pressure chambers.

### DETAILED DESCRIPTION OF EXEMPLARY EMBODIMENTS

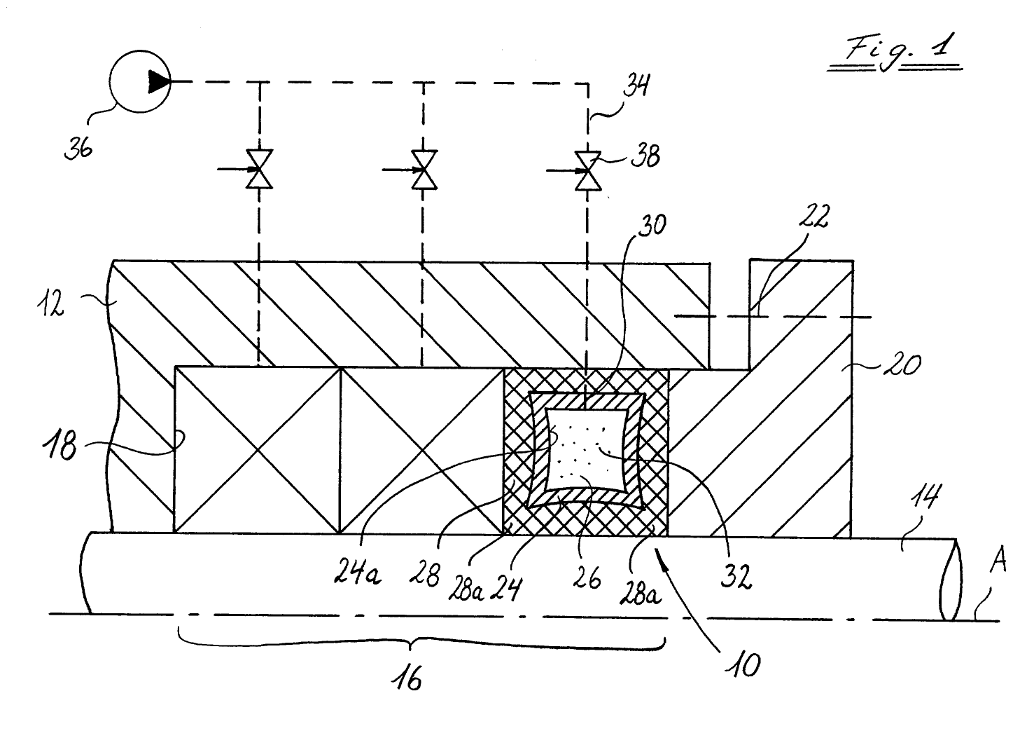

FIG. 1 shows an example of equipment in which a sealing cord 10 according to the invention may be used, in which a shaft 14 is seated in a bearing 12 and is rotatable about the axis A. The sealing cord 10 is part of a packing 16, which, in the example shown, comprises three sealing cords 10 arranged one after another in axial direction. For clarity of illustration, only the cross section of the rightmost sealing cord 10 is shown in FIG. 1, the other two sealing cords 10 being roughly indicated as crossed squares and having the same cross-sectional configuration. The three sealing cords 10 are accommodated in a packing space 18, which is provided in the shaft bearing 12. In FIG. 1, the packing space 18 is closed toward the right by a cover element 20, which may be fastened to the shaft bearing 12 by, for example, screw bolts indicated schematically at 22.

Each sealing cord 10 comprises a core 24, which is designed as an elastically deformable hollow section with a longitudinal hollow space 26 extending in the longitudinal direction of the sealing cord 10, i.e., circumferentially of the shaft 14. The elastically deformable core 24 is embedded in a braiding 28, as is already disclosed in principle in DE-A-195 32 795, to the disclosure of which reference is hereby made regarding the basic structure of the sealing cord.

Unlike the sealing cord disclosed in DE-A-19532 795, the elastically deformable core 24 according to the present invention comprises a connection 30, indicated only schematically in FIG. 1, via which a pressurized fluid 32 can be introduced into the hollow space 26 serving as a pressure chamber. Under the fluid pressure force acting on its inner limiting wall 24a, the elastically deformable hollow section 24 expands and thus forces the braiding 28 surrounding it in sealing contact against the shaft 14, the shaft bearing 12, the adjacent sealing cords and possibly the cover part 20. In the embodiment of FIG. 1, the sections of the limiting wall 24a turned toward the adjacent sealing cord, the shaft 14 and the cover part 20 are convex toward the pressure chamber 26. As a result, the convex wall sections stretch upon expansion of the hollow section 24, owing to which the sealing effect is reinforced, especially in the comers 28a of the braiding 28 critical for sealing.

The pressure fluid 32 is supplied to the pressure chamber 26 by a pump 36 via a supply line 34. The supply quantity may be controlled via an adjustable valve 38, which is part of a control means not shown in detail. Suitable valves and supply lines are also provided for the two other sealing cords of the embodiment of FIG. 1.

Since, according to the invention, pressurized fluid can thus be individually supplied to all sealing cords, all sealing cords 10 contribute to sealing in the same way. The usual decline in sealing effect from the rightmost sealing cord in FIG. 1 to the leftmost sealing cord in FIG. 1 experienced in conventional packings can thus be avoided.

The pressure of the pressurized fluid 32 supplied to the sealing cords 10 by the pump 36 could in principle be adjusted by means of a common valve 38. However, the provision in each instance of a separate valve 38 for each of the sealing cords 10 has the advantage that a desired pressure gradient or even, if necessary, one varying in the direction of axis A can be set.

In addition, in case of wear of the outer surface of the braiding 28 facing the shaft 14, such wear can be compensated for in simple fashion by increasing the fluid pressure.

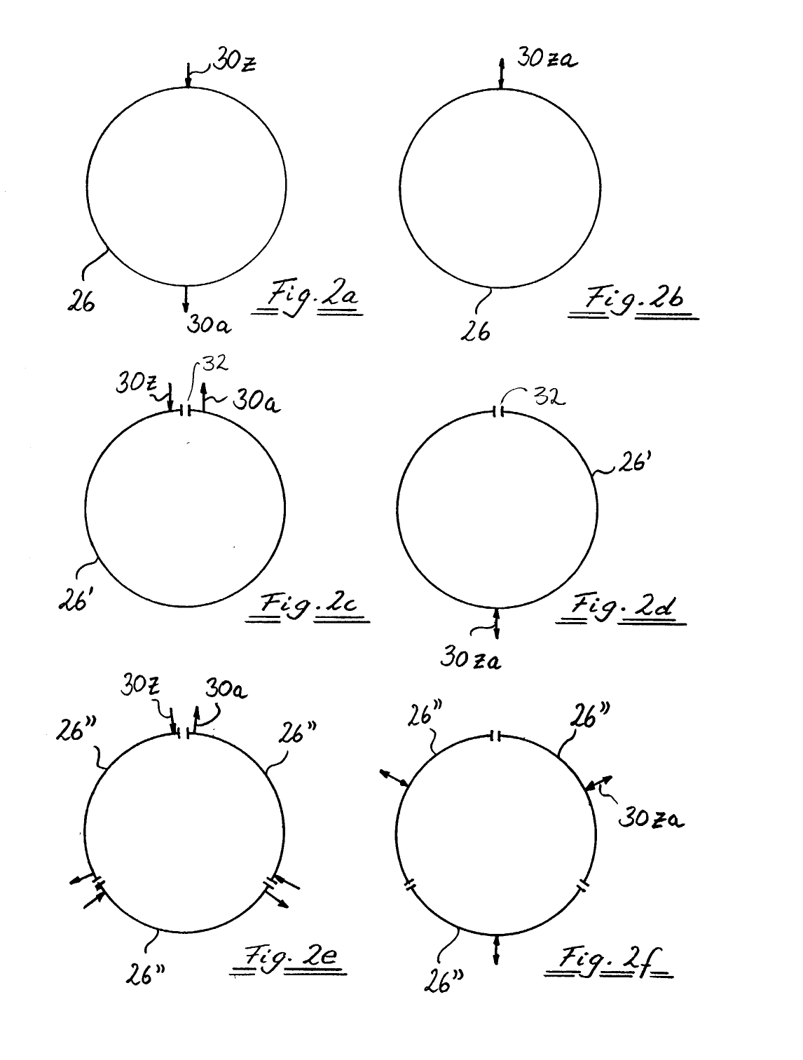

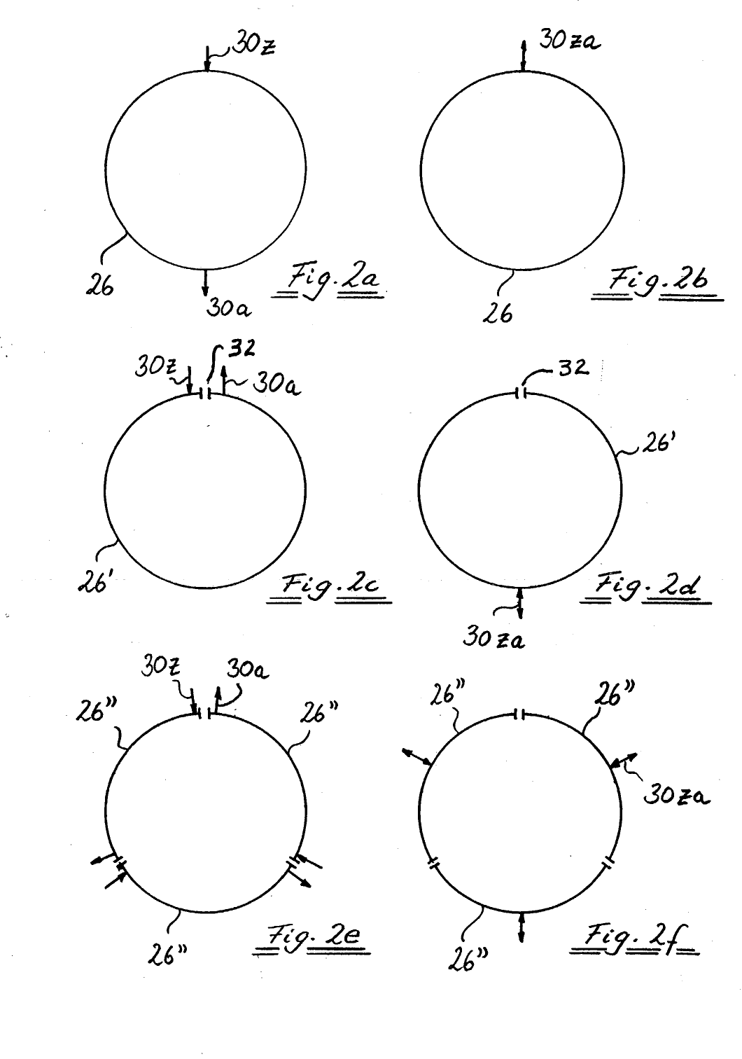

As shown in FIG. 2a, it is advantageous when, in a self-contained ring-shaped or annular-shaped pressure chamber 26, separate connections 30z (supply) and 30a (discharge) are provided for the supply and discharge, respectively, of pressurized fluid in each instance. In principle, however, it is alternatively possible to provide only a single connection 30za, which serves for the supply as well as for the discharge of pressurized fluid (FIG. 2b). As is shown in FIGS. 2c and 2d, this applies in corresponding fashion even when the basically ring-shaped pressure chamber 26′ is not designed as a self-contained endless annular chamber, i.e., when there is one or more interruptions 32 in the ring-shaped chamber 26′. Lastly, according to FIGS. 2e and 2f, a plurality of circumferentially-spaced pressure chambers 26″ may alternatively be provided, which together surround the shaft 14 and may in each instance be equipped with separate connections 30z for the supply and 30a for the discharge of pressurized fluid, or a common connection 30za for the supply and discharge of pressurized fluid.

What is claimed is:

1. A sealing cord for sealing between opposed parts, comprising:
a core having an elastically deformable hollow section, the hollow section comprising at least one chamber;
at least one fluid connection to the at least one chamber for the supply and/or the discharge of pressurized fluid; and
a braiding surrounding the core.

2. The sealing cord according to claim 1, wherein the at least one pressure chamber is formed by a limiting wall, and wherein said limiting wall, in a substantially orthogonal cross section, is convex toward the pressure chamber, at least in sections.

3. The sealing cord according to claim 1, wherein a plurality of pressure chambers are distributed over the lengthwise cross section of the core.

4. The sealing cord according to claim 1, wherein the at least one chamber is a self-contained, endless annular chamber.

5. The sealing cord according to claim 1, wherein the sealing cord has a self-contained endless course, and a plurality of separate chambers is provided along said course.

6. The sealing cord according to claim 1, wherein the at least one pressure chamber has a common connection for the supply and discharge of pressurized fluid.

7. The sealing cord according to any of claim 1, wherein the at least one pressure chamber has separate connections for the supply and discharge, respectively, of pressurized fluid.

8. The sealing cord according to claim 7, wherein the pressurized fluid simultaneously serves as a cooling fluid.

9. The sealing cord according to claim 1, wherein the pressurized fluid is nitrogen gas.

10. The sealing cord according to claim 1, wherein the elastically deformable hollow section is made of at least one of silicon, EPDM, Viton, polyethylene, polypropylene, and polytetrafluoroethylene.

11. A packing system for sealing between opposed parts comprising a plurality of sealing cords interposed between the opposed parts, wherein each of said sealing cords comprises:
a core having an elastically deformable hollow section having at least one chamber therein;
at least one fluid connection to said at least one chamber for the supply and/or the discharge of pressurized fluid; and
a braiding surrounding the core.

12. The packing system of claim 11, wherein the at least one pressure chamber is formed by a limiting wall, and wherein the limiting wall of the at least one pressure chamber, in a substantially orthogonal cross section, is convex toward the pressure chamber, at least in sections.

13. The packing system of claim 11, wherein the sealing core of each cord comprises a plurality of pressure chambers distributed over the lengthwise cross section of said each core.

14. The packing system of claim 11, wherein the at least one chamber is a self-contained, endless annular chamber.

15. The packing assembly of claim 11, wherein each sealing cord has a self-contained endless course, and a plurality of separate chambers is provided along said course.

16. The packing assembly of claim 11, wherein the at least one pressure chamber has a common connection for the supply and discharge of pressurized fluid.

17. The packing assembly of claim 11, wherein the at least one pressure chamber has separate connections for the supply and discharge, respectively, of pressurized fluid.

18. The packing assembly of claim 11, wherein the pressurized fluid simultaneously serves as a cooling fluid.

19. The packing system of claim 11, further comprising a pump for supplying the fluid under pressure to the at least one chamber of each sealing cord.

20. The packing system of claim 11, further comprising control means for controlling the supply and/or discharge of pressurized fluid to each of said sealing cords.

21. The packing system of claim 20, wherein said control means comprises a valve for individually controlling the fluid supply and/or discharge for each of said sealing cords.
